(19) United States
(12) Patent Application Publication
(10) Pub. No.: US 2004/0095913 A1
(43) Pub. Date: May 20, 2004

(54) Routing optimization proxy in IP networks

(75) Inventor: Cedric Jean Alfred Westphal, San Francisco, CA (US)

Correspondence Address: DARBY & DARBY P.C., P.O. BOX 5257, NEW YORK, NY, 10150-6257, US

(73) Assignee: Nokia, Inc., Irving, TX (US)

(21) Appl. No.: 10/301,482

(22) Filed: Nov. 20, 2002

(51) Int. Cl. H04L 12/28

(52) U.S. Cl. 370/338; 370/401

(57) ABSTRACT

A system and method provides a routing optimization proxy in an IP network. A secure association is established between a corresponding node and the routing optimization proxy. An authentication procedure is performed for binding updates between the mobile node and the corresponding node. Packets from the corresponding node to the mobile node are addressed by the routing optimization proxy. Routes taken by the packets may be optimized.

### BACKGROUND OF THE INVENTION

Within conventional IP networks, packets designated to a roaming mobile node are not able to reach it while the node is away from its home link. In order to continue communication in spite of the node's movement, the node could change its IP address each time it moves to a new link. Currently, one possible technique for the mobile node to communicate with other nodes in the network (corresponding nodes) while roaming is to use a home agent. Using this technique, a corresponding node does not need to be aware of a mobile node's actual address. Instead, the corresponding node can communicate with the mobile node through its home agent and home address. The home agent then forwards traffic back and forth between the corresponding node and the mobile node. This approach, however, suffers from non-optimal routing since packets may have to go through a long and time-consuming detour through the home agent. An efficient system that enables a mobile node to communicate with a corresponding node, without superfluous routing, eludes those skilled in the art.

### SUMMARY OF THE INVENTION

The present invention is directed at providing a routing optimization proxy in an IP network. In one aspect, the invention is directed to a method for interacting with a mobile node in an IP network using a routing optimization proxy. The method establishes an association between a corresponding node and a routing optimization proxy. An authentication procedure is performed for binding updates between the mobile node and the corresponding node. The method enables communication between the mobile node and the corresponding node through the routing optimization proxy.

In another aspect, the invention is directed to a communication system in an IP network. The communication system includes a mobile node and a corresponding node that includes a routing optimization proxy. The mobile node connects to the IP network through a foreign link. The routing optimization proxy is configured to enable routing optimization for communication between the mobile node and the corresponding node.

In yet another aspect, the invention is directed to an IP network device. The device includes a processor and a memory. The memory is encoded with computing-executable instructions that include establishing a secure association with a corresponding node; determining a mobile node connected to an IP network on a foreign link; and addressing packets from the corresponding node to the mobile node using a care-of address of the mobile node.

### BRIEF DESCRIPTION OF THE DRAWINGS

FIG. 1 illustrates a diagram where a mobile node communicates with a corresponding node in an IP network;

FIG. 2 illustrates a diagram where a mobile node communicates with corresponding nodes having a routing optimization proxy;

FIG. 3 illustrates a schematic diagram illustrating an exemplary authentication procedure for binding between a mobile node and a corresponding node having a routing optimization proxy;

FIG. 4 illustrates an operational flow diagram of a process for communicating between a mobile node and a corresponding node having a routing optimization proxy; and

FIG. 5 illustrates a routing optimization server in one exemplary configuration; according to embodiments of the invention.

### DETAILED DESCRIPTION OF THE PREFERRED EMBODIMENT

In the following detailed description of exemplary embodiments of the invention, reference is made to the accompanied drawings, which form a part hereof, and which is shown by way of illustration, specific exemplary embodiments of which the invention may be practiced. Each embodiment is described in sufficient detail to enable those skilled in the art to practice the invention, and it is to be understood that other embodiments may be utilized, and other changes may be made, without departing from the spirit or scope of the present invention. The following detailed description is, therefore, not to be taken in a limiting sense, and the scope of the present invention is defined only by the appended claims.

Throughout the specification and claims, the following terms take the meanings explicitly associated herein, unless the context clearly dictates otherwise.

The term “IP” means any type of Internet Protocol.

The term “node” means a device that implements IP.

The term “router” means a node that forwards IP packets not explicitly addressed to itself.

The term “routable address” means an identifier for an interface such that a packet is sent to the interface identified by that address.

The term “link” means a communication facility or medium over which nodes can communicate.

The term “home address” means a routable address assigned to a mobile node, used as the permanent address of the mobile node.

The term “home link” means the link pointed to by a mobile node's home address.

The term “foreign link” means any link other than the mobile node's home link.

The term “mobile node” means a node that can change its point of attachment from one link to another, while still being reachable via its home address.

The term “correspondent node” means peer node with which a mobile node is communicating. The correspondent node may be either mobile or stationary.

The term “care-of address” means a routable address associated with a mobile node while visiting a foreign link.

The term “home agent” means a router on a mobile node's home link with which the mobile node has registered its current care-of address. While the mobile node is away from home, the home agent intercepts packets on the home link destined to the mobile node's home address, encapsulates them, and tunnels them to the mobile node's registered care-of address.

The term “binding” means the association of the home address of a mobile node with a care-of address for that mobile node, along with the remaining lifetime of that association.

Referring to the drawings, like numbers indicate like parts throughout the views. Additionally, a reference to the singular includes a reference to the plural unless otherwise stated or is inconsistent with the disclosure herein.

A mobile node and a corresponding node may directly communicate after a home agent performed steps to authenticate and authorize the communication. Routes for communication in an IP network are typically determined using routing protocols, such as Routing Information Protocol (RIP) and Open Shortest Path First (OSPF). The use of the shortest (with respect to the routing algorithm) route between the mobile node and the corresponding node is called routing optimization. By implementing routing optimization, packets may take a straightforward route between the mobile node and the corresponding node without being detoured through a home agent.

Routing optimization, however, is costly for the corresponding node, especially when the corresponding node is a static server handling transactions for many clients. To have routing optimization capabilities, the corresponding node would have to implement many extra states and protocols, which would require constant upgrades in order to cater to mobile users. Also, if the mobile node communicates with many corresponding nodes in a particular system, each of the corresponding nodes would have to be upgraded to have routing optimization capabilities.

The present invention is directed at providing a routing optimization proxy to a corresponding node for communicating with a mobile node. The system and method of the invention enable the corresponding node to have routing optimization capabilities without requiring superfluous components and upgrades. Routing optimization for multiple corresponding nodes may be centrally enabled by a server. These and other aspects of the invention will become apparent after reading the following detailed description.

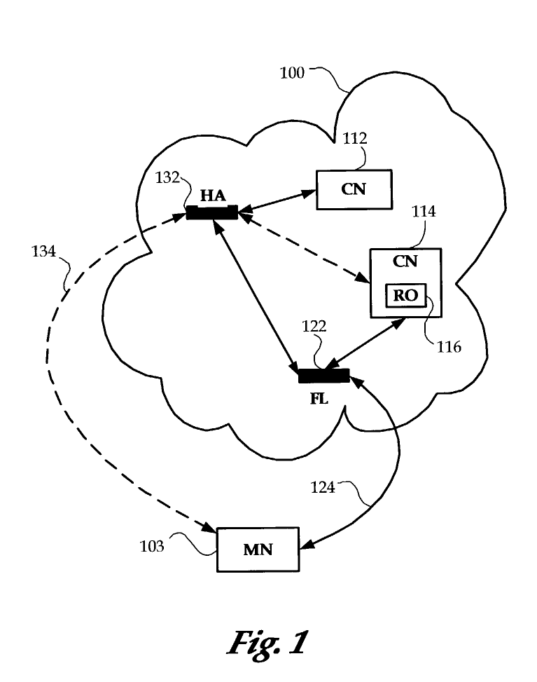

FIG. 1 illustrates a diagram where a mobile node communicates with a corresponding node in an IP network. As shown in the figure, mobile node 103 is at a location that is too remote for connecting to IP network 100 through home agent 132 using wireless connection 134. To establish connectivity at its current location, mobile node 103 connects to IP network 100 through foreign link 122 with wireless connection 124.

Communications between mobile node 103 and corresponding nodes may route through home agent 132. Home agent 132 is configured to handle communication traffic between corresponding node 112 and mobile node 103. Corresponding node 112 sends packets intended for mobile node 103 to home agent 132. Home agent 132 then forwards the packets to mobile node 103 through foreign link 122 using the primary care of address associated with mobile node 103. This implementation enables corresponding node 112 to communicate with mobile node 103 without requiring corresponding node 112 to be aware of the care of address associated with mobile node 103 at its current location. However, because the packets intended for mobile node 103 have to route through a possibly long and time consuming detour via home agent 132, this implementation is not an efficient way to handle communication for mobile node 103 while it is away from home agent 132.

In another implementation, corresponding node 112 may directly communicate with mobile node 103. Corresponding node 114 may contact home agent 132 for authenticating and authorizing communication with mobile node 103. After the communication was authenticated and authorized, corresponding node 114 may send packets directly to mobile node 103 without going through home agent 132. As shown in the figure, corresponding node 114 may include routing optimization software component 116 that enables the use of the shortest route for packets going between mobile node 103 and corresponding node 114. In order to ensure the integrity of the communication, both corresponding node 114 and mobile node 103 may agree on using the routing optimization. Accordingly, states and protocols associated with the routing optimization are implemented and maintained.

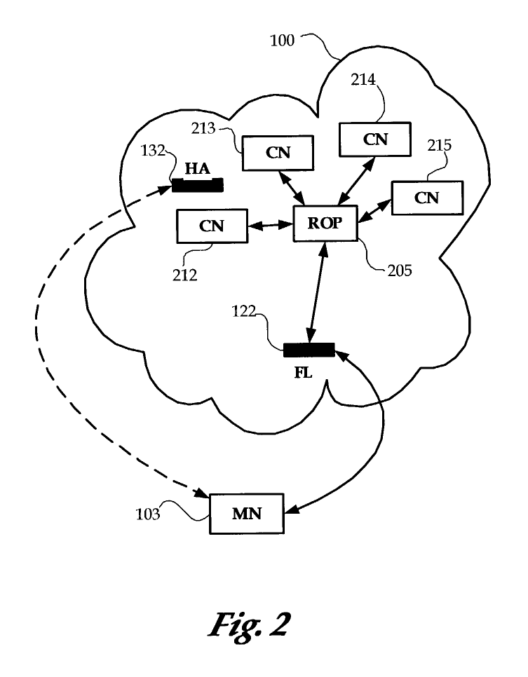

FIG. 2 illustrates a diagram where a mobile node communicates with corresponding nodes having a routing optimization proxy. As in FIG. 1, mobile node 103 is at a remote location from home agent 132 and connects to IP network 100 through foreign link 122. As shown FIG. 2, mobile node 103 communicates with a cluster of corresponding nodes 212-215, which offload the work associated with enabling routing optimization to routing optimization proxy 205.

Routing optimization proxy 205 may be implemented in various configurations. In one exemplary configuration, routing optimization proxy 205 is implemented as a server capable of enabling routing optimization for multiple clients. Routing optimization proxy 205 may also be implemented as a firewall so that all traffic to and from corresponding nodes 212-215 have to go through routing optimization proxy 205. In the firewall implementation, all regular traffic to the server is forwarded on the fast path. Traffic necessitating additional processing is the security related traffic. Which traffic requires additional processing depends on the security level requested by the client and the server. In another implementation, routing optimization proxy 205 may use a Network Address Translation (NAT) standard to forward packets in an internal network.

In operation, each of the corresponding nodes 212-215 maintains a secure association with routing optimization proxy 205. The secure association can be implemented by manual configuration or using a public key infrastructure. Routing optimization proxy 205 enables routing optimization for corresponding nodes 212-215. In particular, routing optimization may be configured to address packets to and from mobile node 103 using the care-of address of the mobile node. From the point of view of corresponding nodes 212-215, they may not be aware that the routes for sending packets to mobile node 103 are optimized using routing optimization proxy 205. From the point of view of mobile node 103, it may not be aware that routing optimization proxy 205 is handling routing optimization for traffic between mobile node 103 and corresponding nodes 212-215.

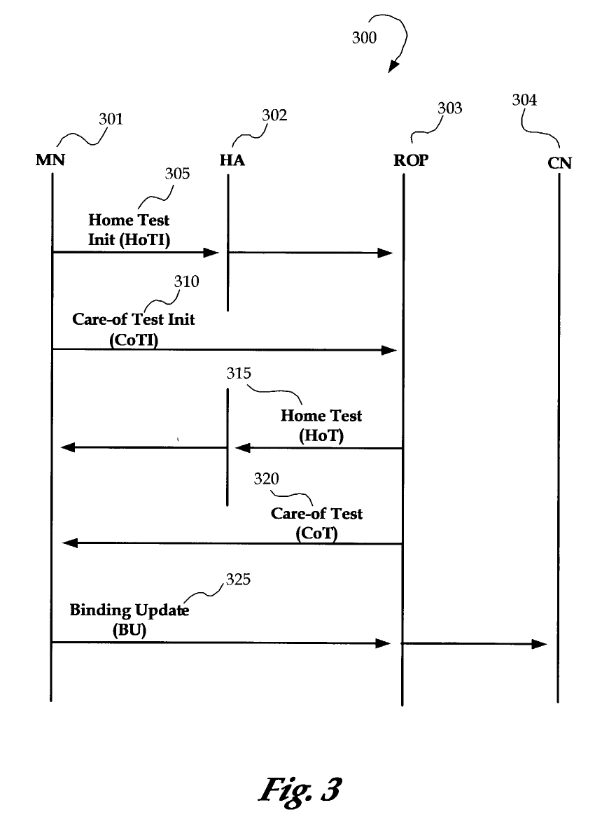

FIG. 3 illustrates a schematic diagram illustrating an exemplary authentication procedure for binding between a mobile node and a corresponding node having a routing optimization proxy. Conventional authentication procedures are described in more detail in IETF specifications. Briefly stated, an authentication procedure for binding enables the corresponding node to obtain some assurance that the mobile node is in fact addressable at its claimed care of address as well as its home address. With this assurance, the corresponding node will be able to accept binding updates from the mobile node for sending packets to the care of address of the mobile node. Conventional authentication procedures include Home Test Init/ Care-of Test Init (HoTI/CoTI) exchange, IP Security (IPSec), Cryptographically Generated Addresses (CGA), and the like.

In FIG. 3, an exemplary HoTI/CoTI exchange authentication procedure 300 for a corresponding node 304 having a routing optimization proxy 303 is illustrated. Authentication procedure 300 may occur after corresponding node 304 and routing optimization proxy 303 have established a secure association. In this embodiment, routing optimization proxy 303 performs the exchange authentication procedure for corresponding node 304.

Authentication procedure 300 begins when the mobile node 301 sends a Home Test Init (HOTI) message 305 to the corresponding node 304 through a home agent 302. The content of the HoTI message may include:

source address which may be a home address;

destination address which may be a corresponding address; and

parameters: hot init cookie.

Mobile node 301 sends a Care-of Test Init (CoTI) message (310) to corresponding node 304. The content of the CoTI message may include:

source address which may be a care-of address;

destination address which may be a corresponding address; and

parameters: care-of init cookie.

In response to HoTI message 305, routing optimization proxy 303 (on behalf of corresponding node 304) may send a Home Test (HoT) message 315 to mobile node 301 through the home agent. HoT message 315 may include:

source address which may be a corresponding address;

destination address which may be a home address; and

parameters: HoT cookie; home cookie; home nonce index.

In response to CoTI message 310, routing optimization proxy 303 (on behalf of corresponding node 304) may send a Care-of Test (CoT) message (320) to the mobile node. CoT message 320 may include:

source address which may be a corresponding address;

destination address which may be a care-of address; and

parameters: CoT cookie; care-of cookie; care-of nonce index.

After the HoTI, HoT, CoTI and CoT messages are sent, mobile node 301 may send a binding update 325 to the corresponding node to create a binding between the two nodes. Routing optimization proxy 303 may send an optional binding acknowledgement to the mobile node in response to the binding update.

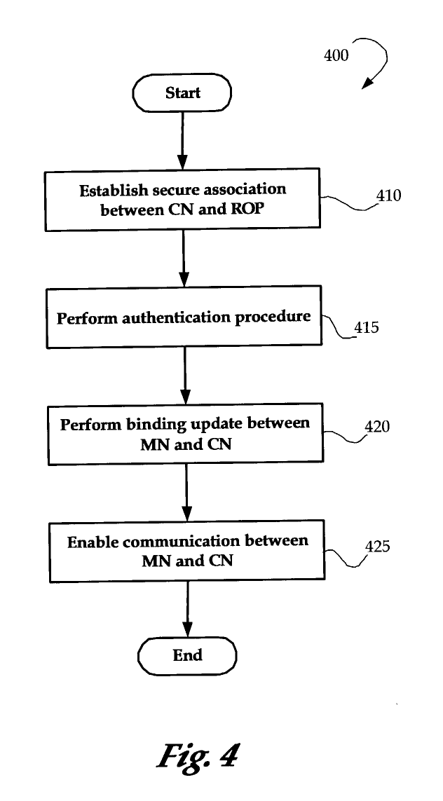

FIG. 4 illustrates an operational flow diagram of a process for communicating between a mobile node and a corresponding node having a routing optimization proxy. Moving from a start block, process 400 moves to block 410 where a secure association is established between the corresponding node and the routing optimization proxy. The secure association may be established using conventional authentication procedures or other authentication procedures. The process continues at block 415.

At block 415, an authentication procedure for binding updates between the mobile node and the corresponding node is performed. A procedure such as authentication procedure 300 shown in FIG. 3 may be used such that the routing optimization proxy handles the authentication on behalf of the corresponding node. At block 420, a binding update between the mobile node and the corresponding node is performed. At block 425, communication between the mobile node and the corresponding node is enabled such that packets sent between the two nodes take a route determined by the routing optimization proxy. Process 400 then ends.

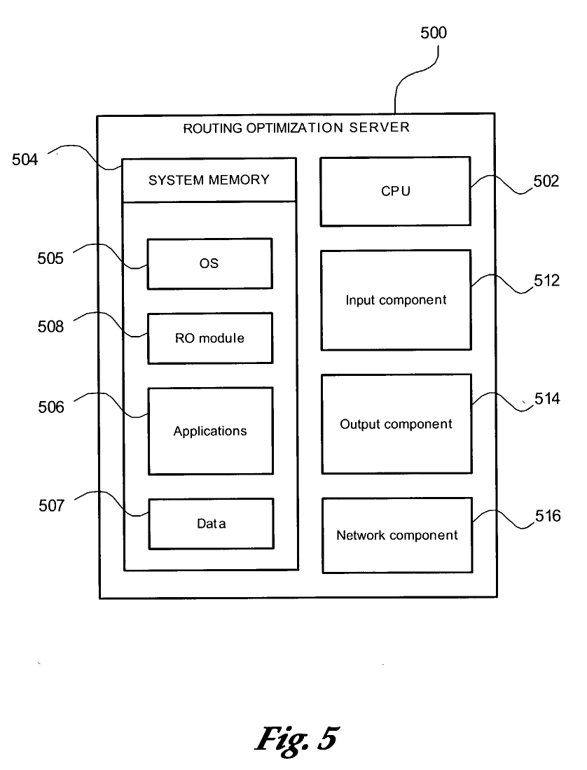

FIG. 5 illustrates a routing optimization server in one exemplary configuration. For illustrative purposes, routing optimization server 500 is only shown with a subset of the components that are commonly found in a computing device. A computing device that is capable of implementing this invention may have more, less, or different components as those shown in FIG. 5. Routing optimization server 500 may include various hardware components. In a very basic configuration, routing optimization server 500 typically includes central processing unit 502, system memory 504, and network component 516.

Depending on the exact configuration and type of computing device, system memory 504 may include volatile memory, non-volatile memory, data storage devices, or the like. These examples of system memory 504 are all considered computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by routing optimization server 500. Any such computer storage media may be part of routing optimization server 500.

Routing optimization server 500 may include input component 512 for receiving input. Input component 512 may include a keyboard, a mouse, or other input devices. Output component 514 may include a display, speakers, printer, and the like.

Routing optimization server 500 may also include network component 516 for communicating with other devices in an IP network. In particular, network component 516 enables routing optimization server 500 to communicate with mobile nodes and corresponding nodes. Routing optimization server 500 may be configured to use network component 516 to receive and send packets to and from the corresponding nodes and the mobile nodes. In this configuration, routing optimization server 500 serves as a routing optimization proxy for the corresponding nodes.

Signals sent and received by network component 516 are one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Software components of routing optimization server 500 are typically stored in system memory 504. System memory 504 typically includes an operating system 505, one or more applications 506, and data 507. As shown in the figure, system memory 504 may also include a routing optimization module 508. Routing optimization module 508 is a software component for processing packets associated with corresponding nodes that use routing optimization server 500 as a routing optimization proxy. Routing optimization module 508 includes computer-executable instructions for addressing packets going between mobile nodes and the corresponding nodes.

The above specification, examples and data provide a complete description of the invention. Since many embodiments of the invention can be made without departing from the spirit and scope of the invention, the invention resides in the claims hereinafter appended.

What is claimed is:

1. A method for interacting with a mobile node in an IP network comprising:
establishing an association between a corresponding node and a routing optimization proxy;
performing an authentication procedure for binding updates between the mobile node and the corresponding node; and
communicating between the mobile node and the corresponding node through the routing optimization proxy.

2. The method of claim 1, further comprising addressing packets from the corresponding node to the mobile node using a care-of address of the mobile node.

3. The method of claim 2, further comprising sending at least one of the packets from the corresponding node to the mobile node using an optimized route.

4. The method of claim 1, further comprising addressing packets from the corresponding node to the mobile node using Network Address Translation.

5. The method of claim 1, wherein establishing the association between the corresponding node and the routing optimization proxy, further comprises establishing a secure association.

6. The method of claim 5, wherein the secure association is established by a manual configuration.

7. The method of claim 5, wherein the secure association is established by a public key infrastructure.

8. The method of claim 1, wherein the routing optimization proxy is implemented as a server.

9. The method of claim 1, wherein the routing optimization proxy is implemented as a firewall.

10. The method of claim 1, wherein the authentication procedure is performed using at least one of the following: an HoTI/CoTI exchange, an IPSec procedure; and a CGA procedure.

11. A communication system in an IP network comprising:
a mobile node connecting to the IP network through a foreign link;
a corresponding node; and
a routing optimization proxy configured to maintain an association with the corresponding node and to enable routing optimization for communication between the mobile node and the corresponding node.

12. The communication system of claim 11, wherein the routing optimization proxy is configured to address packets from the corresponding node to the mobile node using a care-of address of the mobile node.

13. The communication system of claim 12, wherein at least one of the packets is sent using an optimized route.

14. The communication system of claim 11, wherein the routing optimization is configured to perform an authentication procedure for binding updates between the mobile node and the corresponding node.

15. The communication system of claim 11, wherein the association between the routing optimization proxy and the corresponding node is a secure association.

16. The communication system of claim 11, wherein the routing optimization proxy is implemented as a server.

17. The communication system of claim 11, wherein the routing optimization proxy is implemented as a firewall.

18. The communication system of claim 11, wherein the routing optimization proxy is configured to address packets using Network Address Translation.

19. The communication system of claim 11, wherein the routing optimization proxy is configured to interact with multiple corresponding nodes.

20. The communication system of claim 11, wherein the routing optimization proxy is configured to handle at least one of the following: a public key infrastructure, an HoTI/CoTI exchange, an IPSec procedure, and a CGA procedure.

21. The communication system of claim 11, wherein the corresponding node is a static server.

22. An IP network device comprising:
a processor; and
a memory encoded with computer-executable instructions comprising:
establishing a secure association with a corresponding node;
determining a mobile node connected to an IP network on a foreign link; and
addressing packets from the corresponding node to the mobile node using a care-of address of the mobile node.

23. The IP network device of claim 22, wherein the computer-executable instructions further comprise performing an authentication procedure for binding updates between the corresponding node and the mobile node.

24. The IP network device of claim 22, wherein the computer-executable instructions further comprise sending at least one of the packets using an optimized route.

25. The IP network device of claim 22, wherein the computer-executable instructions further comprise addressing at least one of packets to the mobile node using Network Address Translation.

26. A system comprising:
means for establishing an association between a corresponding node and a routing optimization proxy;
means for performing an authentication procedure for binding updates between a mobile node and the corresponding node; and
means for communicating between the mobile node and the corresponding node through the routing optimization proxy.

27. The method of claim 26, further comprising means for addressing packets from the corresponding node to the mobile node using a care-of address of mobile node.

28. The system of claim 27, further comprising means for sending packets from the corresponding node to the mobile node using an optimized route.

29. The method of claim 28, further comprising means for establishing a secure association between the corresponding node and the routing optimization proxy.
